(19) United States
(12) Patent Application Publication
(10) Pub. No.: US 2009/0132607 A1
(43) Pub. Date: May 21, 2009

(54) TECHNIQUES FOR LOG FILE PROCESSING

(76) Inventors: Lorenzo Danesi, (US); Randal May, (US); Zhenrong Michael Li, (US); David Chan, (US); James Zhang, (US)

Correspondence Address: JAMES M. STOVER;TERADATA CORPORATION, 2835 MIAMI VILLAGE DRIVE, MIAMISBURG, OH, 45342, US

(21) Appl. No.: 11/941,110

(22) Filed: Nov. 16, 2007

(51) Int. Cl. G06F 17/30

(52) U.S. Cl. 707/202; 707/E17.005

(57) ABSTRACT

Techniques for log file processing are provided. Multiple user-defined functions process in parallel on different nodes of a network. Each user-defined function on a particular node creates its own log file. All the log files are represented by the same identifier within their respective node environments. When access to the log files is requested, all the log files are accessed and merged automatically into a single database table for centralized viewing and access.

### BACKGROUND

Enterprises are increasingly capturing, storing, and mining a plethora of information related to communications with their customers. Often this information is stored and indexed within databases. Once the information is indexed, queries are developed on an as-needed basis to mine the information from the database for a variety of organizational goals: such as planning, analytics, reporting, etc.

Many times the information stored and indexed is created, mined, updated, and manipulated by application programs created by developers on behalf of analysts. In a large database environment, each application program may process as multiple instances on different nodes of the network. Moreover, each application program includes its own logging techniques and processes.

Logging is done for a variety of reasons, such as debugging when errors occur, auditing to comply with internal or governmental regulations, etc. Trying to effectively use logging techniques that are done within a parallel processing environment can be difficult. Furthermore, logging techniques are often ad hoc; thus, there is little to no reuse of logging techniques.

Therefore, it can be seen that in a parallel processing environment improved techniques are needed for logging activities, which are associated with the processing of database applications.

### SUMMARY

In various embodiments, techniques for log file processing are provided. According to an embodiment, a method for log file processing is described. Initialization requests are received from user-defined functions to create log files. Each user-defined function processes on a different node of a network from remaining ones of the user-defined functions. A same file name is established for each of the log files. Next, messages are written into the log files on the respective nodes of the log files when received from the user-defined functions using the file name.

### BRIEF DESCRIPTION OF THE DRAWINGS

FIG. 1 is a diagram of a method for processing log files, according to an example embodiment.

FIG. 2 is a diagram of another method for processing log files, according to an example embodiment.

FIG. 3 is a diagram of a log file processing system, according to an example embodiment.

### DETAILED DESCRIPTION

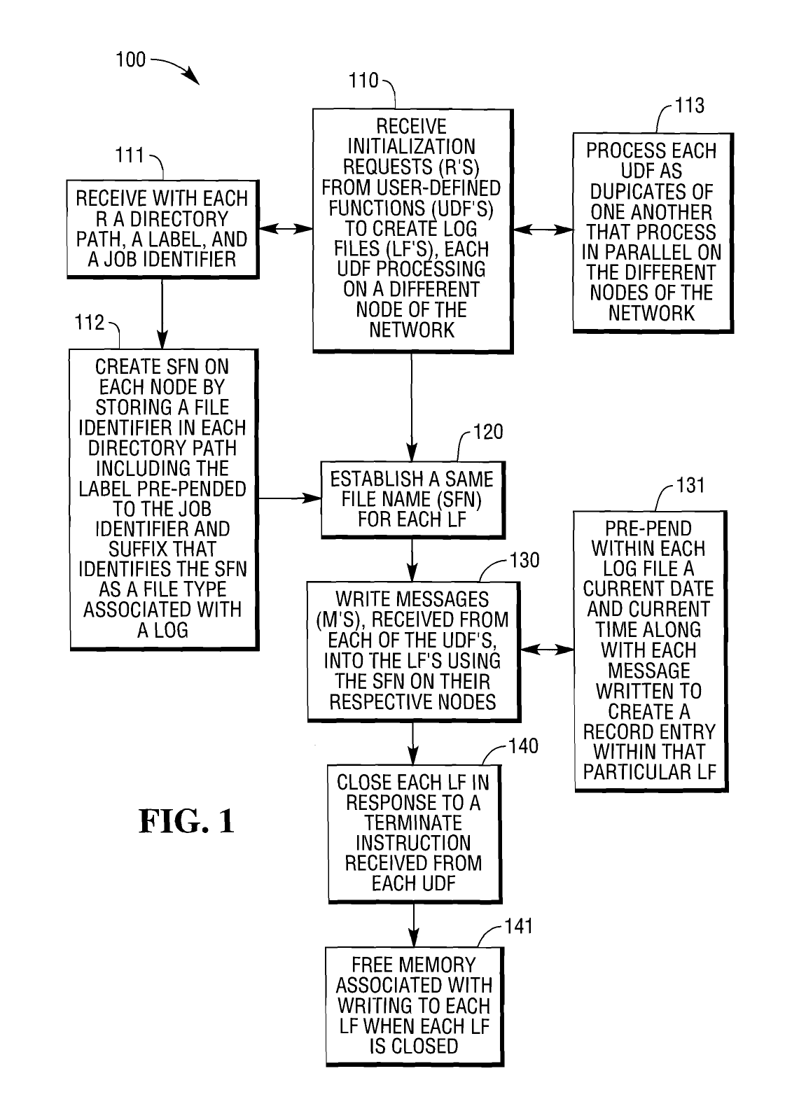

FIG. 1 is a diagram of a method 100 for processing log files, according to an example embodiment. The method 100 (hereinafter “logging service”) is implemented in a machine-accessible or computer-readable medium as instructions that when executed by a machine (e.g., computer, processing device, etc.) performs the processing depicted in FIG. 1. Moreover, the logging service is accessible over a network. The network may be wired, wireless, or a combination of wired and wireless.

A “database” as used herein is a relational database, or a collection of databases organized as a data warehouse. According to an embodiment, the database is a Teradata® product or service distributed by NCR Corporation of Dayton, Ohio.

The database includes a variety of enterprise information organized in tables, One type of information is referred to as an “entity.” An entity is something that can be uniquely identified (e.g., a customer account, a customer name, a household name, a logical grouping of certain types of customers, etc.).

In an embodiment, the logging service is implemented as a series of executable modules that are callable from within programs via an Application Programming Interface (API) library that includes the modules.

It is within this context that the processing associated with the search service is now described in detail with reference to the FIG. 1.

At 110, the logging service receives initialization requests from user-defined database functions to create log files. Each user-defined function processes on a different node of a network and processes in parallel with remaining ones of the user-defined functions. The order or timing of that the initialization requests are received can occur in any manner. Thus, there is no order or timing sequence whenever a particular user-defined function desires to create a log file for the node on which it is processing; it makes an initialization request that is detected by the logging service and handled in the manners discussed herein and below.

According to an embodiment, at 111, the logging service receives with each initialization request a particular directory path, a label for the log file it desires and a job identifier.

In still another case, at 112, the logging service a same exact file name on each node of the network by storing a file identifier in each location of that particular node that is identified by the directory path, which is pre-pended to label. The label is pre-pended to the job identifier, and the job identifier is pre-pended to a suffix that identifies the log file as a type of file associated with a log.

For example, consider a directory path of “/tmp”, a label as “foo”, a job identifier as “123”, and a file type suffix as “.log.” The logging service creates a same file name on each node identified by the string: “/tmp/foo_{—}132.log.”

It is understood that other techniques may be used as well to create a unique name that can be subsequently reconstructed and found on each node and that is unique within a processing environment of each node, but that may not be unique across nodes. For example, the label can be the name of the user-defined function making the call; a set directory can house the log files on each node and can be configured into the logging service as a configuration parameter. In another situation, a random number generator can supply a reference name to the user-defined functions and be passed to the logging service as well. So, the exact technique discussed above can vary and embodiments of the invention are not intended to be solely restricted to the exact example presented above.

Again, at 113, the logging service may recognize that each of the user-defined functions are processing as duplicates of one another and in parallel with one another on different nodes of the network.

At 120, the logging service establishes a same file name for each log file created. That is, each log file on each node has the same file name, such that the file name is unique within any particular node processing environment or directory structure but not unique across the different nodes and their processing environments.

At 130, the logging service writes messages as they are received from each of the user-defined functions into the log files associated with the same file name. The logging service uses the same file name to access a particular node and its directory structure for a particular user-defined function and then writes the messages to that log file associated with that directory structure and file name. The process is similar for a different message from a different user-defined function processing on a different node in that the same file name is used.

For example, a first user-defined function U1 uses a first node to process on N1 and writes a first message M1 to a log file identified by a label or reference X, the write occurs via a call to the logging service. Simultaneously and in parallel, a second user-defined function U2 (perhaps a duplicate instance of U1) uses a second node to process on N2 and writes a message M2 to the log file identified by the label X; again, the write occurs via a call to the logging service. So, each separate log file includes different messages M1 and M2 and reside on different nodes of the network N1 and N2.

In an embodiment, at 131, when each message is written to their respective log files, the logging service pre-pends within each record of each log file a current date and a current time associated with a particular message being written. So, in the above example if M1 was written to the first log file on N1 the entry within that log file may appear as follows December 1, 2007 1500 M1; where 1500 is military time for 3:00 pm. M2 may appear in its log file as December 1, 2007 1500 M2.

According to an embodiment, at 140, the logging service closes each log file when each of the user-defined functions issue a terminate instruction. This informs the logging service when each user-defined function is finished writing messages to its particular log file on its particular node.

In some cases, at 141, the logging service may then take some clean up processing, such as freeing memory associated with writing to each log file. Other administrative processing may be also be done when the terminate instruction is received by the logging service.

A variety of automated processing may also occur after the single table is produced within the database. For example, an event may be triggered when the table is produced that is detected by an automated service. The automated service may then generate a report or construct other searches in response to information parsed from the table. In some cases, an end-user may subsequently execute searches against the table and produce different views for inspecting the table.

The logging service presents an automated and uniform mechanism for gathering and centrally presenting log information generated from a plurality of user-defined functions that each independently produce log files on separate nodes of a network.

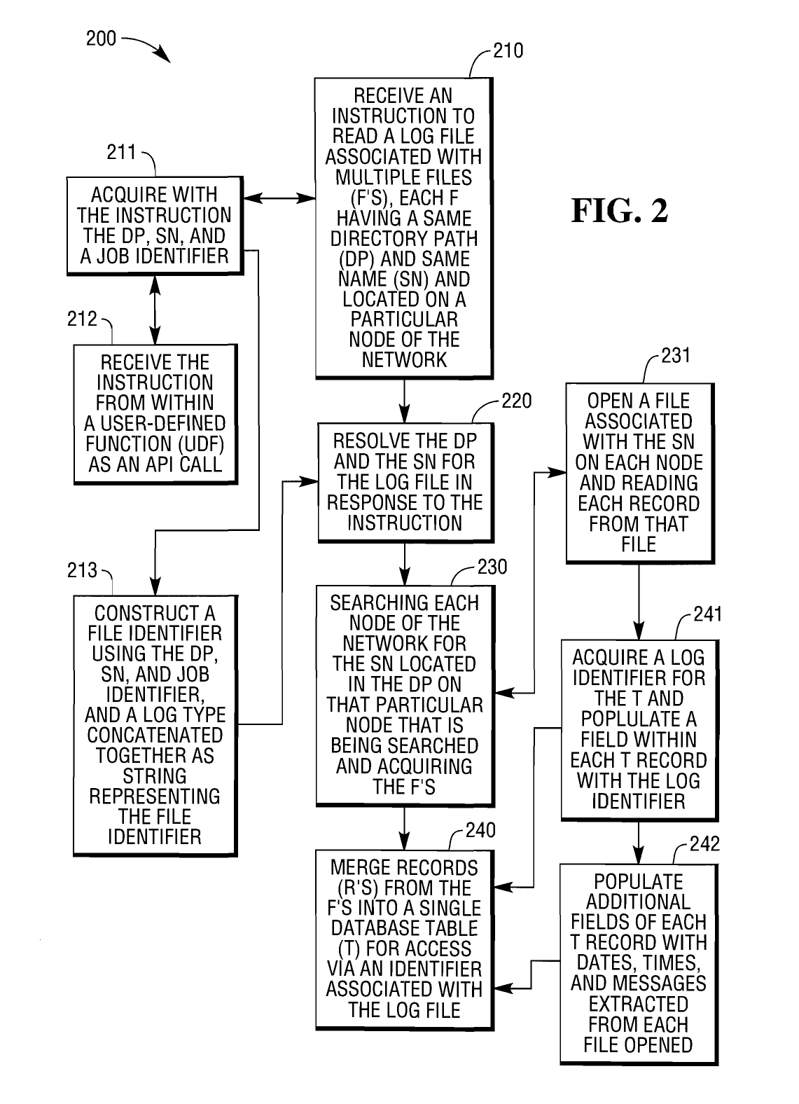

FIG. 2 is a diagram of another method for processing log files, according to an example embodiment. The method 200 (hereinafter “log viewing service”) is implemented in a machine-accessible and readable medium as instructions that when executed by a machine performs the processing reflected in FIG. 2. The log viewing service is accessible over a network. The network may be wired, wireless, or a combination of wired and wireless. The log viewing service presents an enhanced view and different aspect of the logging service presented above and represented by the method 100 of the FIG. 1.

The log viewing service may be viewed as a viewer that allows for the viewing of consolidated logs. The mechanism for initially capturing the independent logs was presented above with reference to the method 100 of the FIG. 1.

At 210, the log viewing service receives an instruction to read a log file. That log file is associated with a plurality of independently produced logs. Each log file has a same directory path and same name and is located on its on particular node of the network. In other words, each log file has a same identifier within a directory system as the other remaining log files; but, each log file resides within its own unique directory system and node on the network, such that there is no collision or duplication within a particular node.

In an embodiment, at 211, the log viewing service acquires the directory path, name, and a job identifier with the instruction. At 212, the log viewing service receives this information from a user-defined function that invokes the processing associated with the log viewing service.

At 213, the log viewing service uses this information to construct a file identifier. According to an embodiment, the file identifier consists of the directory path having the name, job identifier, and a file type identifier concatenated thereto. The concatenated string forms the file identifier.

At 220, the log viewing service resolves the directory path and name in response to the received instruction. Examples associated with resolving the directory path and name were presented above with respect to the method 100 of the FIG. 1 and with respect to the processing at 211 and 212.

At 230, the log viewing service searches each node and its directory structure within the network for the resolved directory path and name. This provides an indication as to when a particular node has a log file that is of interest to the received instruction. This also permits the log viewing service to acquire each of the log files from the nodes of the network.

At 231, the log viewing service opens each log file found and reads each entry/record from that file.

At 240, the log viewing service merges records from the acquired log files into a single database table for subsequent access via an identifier associated with the log file being aggregated into the single database table.

In an embodiment, at 241, the log viewing service also acquires a unique log identifier for the aggregated log files being assembled. The unique log identifier may be inserted with each record as new field for that record within the table.

At 242, additional fields of the record may be added by the log viewing service for the dates, times, and messages that comprise each record acquired from the log files.

For example, suppose a first log file had an entry as follows: December 1, 2006; 1500; AMP1; Process terminated abnormally. The log viewing service creates 5 fields in the database table one for a log file identifier such as Log1, one for the date (December 1, 2006), one for the time (1500—military time for 3:00 pm), one for the node identifier where the log file was found (AMP1), and one for the message text (“Process terminated abnormally”).

This illustrates that the log files may include a variety of information, some of which was described above with reference to the method 100 and some is newly presented, such as the log identifier (which is generated when the table is created) and the node identifier (AMP1). The node identifier may appear in the original log file or may be generated by the log viewing service, since it knows the node in which a particular node was found.

A partitioned primary index (PPI) can also be automatically constructed from the fields of the table generated. The PPI allows for insertion into the table to be efficiently achieved and allows for purging to be efficiently achieved.

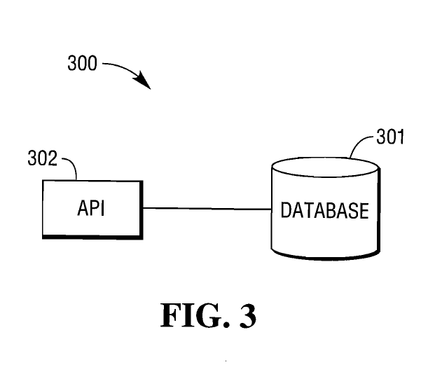

FIG. 3 is a diagram of a log file processing system 300, according to an example embodiment. The log file processing system 300 is implemented in a machine-accessible and readable medium and is operational over a network. The network may be wired, wireless, or a combination of wired and wireless. In an embodiment, portions of the log file processing system 300 implements, among other things the logging service and the log viewing service represented by the methods 100 and 200 of the FIGS. 1 and 2, respectively.

The log file processing system 300 includes a database 301 and an Application Programming Interface (API) 302. Each of these and their interactions with one another will now be discussed in turn.

The database 301 may be a relational database or a collection of relational databases organized and cooperating as a data warehouse. The database 301 resides within and is accessible from a machine-readable medium. According to an embodiment, the database 301 is a Teradata® product distributed by NCR, Corporation of Dayton, Ohio.

The database 301 houses a variety of tables for enterprise data. Each table may have its own schema definition that defines the fields and other aspects of the table and the data that the table may house.

The API 302 is also implemented in a machine-accessible medium and is processed on a machine. Module calls associated with the API 302 are called from within user-defined functions that process on machines of the network and on particular nodes of the network. The API 302 can access the database 301 using a search query interface to create tables, modify tables, search tables, update tables, etc. Example processing associated with modules of the API 302 was presented above in detail with reference to the methods 100 and 200 of the FIGS. 1 and 2, respectively.

The API 302 includes a variety of modules. User-defined functions process on nodes of a network. The user-defined functions may be duplicate instances of one another that process in parallel with one another on entirely different nodes of the network. The user-defined functions make a call to an initialization module associated with the API 302. The initialization module creates a log file on the node to which the user-defined function that made the call is processing. The initialization module may receive as input a directory path, a file name, and a job identifier. With this information, the initialization module creates a particular log file. This was described in detail above with reference to the method 100 of the FIG. 1.

Another API 302 relates to logging messages that the user-defined functions create. The user-defined function makes a call within its logic to the API 302 for writing a message and passes the message. The log file is known or reconstructed and the message is written to the log file. Other information may also be written with the message, such as current date, current time, AMP identifier or node identifier, etc.

Still another API 302 relates to terminating or closing a particular log file. The user-defined function makes a call within its logic to terminate the writing processing. This results in memory being freed up and the file being available for viewing.

Once the log files are created and closed, the API 302 includes yet another module that a user-defined function or other service can access. This viewing module takes as input the directory path, name, and job identifier. Armed with this information, a file identifier is reconstructed and each node of the network is searched for log files with that file identifier (directory path+name+job identifier+file type).

The log files are assembled or aggregated into a single database table of the network. Each parameter or distinguishable field from each record of each log file because a unique field in the database table of the database 301. Another field may be added as well that identifies the table via a unique log table identifier. The table may include a PPI as well for making insertion and deletion achieved in an efficient manner.

The table may be accessed via a database query language interface (such as SQL). In this manner, a plurality of log files are automatically and programmatically aggregated and normalized for centralized access via an interface that is readily known and available to end users.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
receiving initialization requests from user-defined functions to create log files, each user-defined function processing on a different node of a network from remaining ones of the user-defined functions;
establishing a same file name for each of the log files; and
writing messages, received from the user-defined functions, into the log files on their respective nodes using the file name.

2. The method of claim 1, wherein receiving further includes receiving with each of the initialization requests a directory path, a label, and a job identifier.

3. The method of claim 2, wherein establishing further includes creating the file name on each node by storing a file identifier in the directory path of each node, the file identifier including the label pre-pended to the job identifier and including a suffix that identifies the file name as a type of file associated with a log.

4. The method of claim 1, wherein receiving further includes processing each user defined function as duplicates of one another that process in parallel on the different nodes of the network.

5. The method of claim 1, wherein writing further includes pre-pending within each log file a current date and a current time along with each message written to create a record entry within that particular log file.

6. The method of claim 1 further comprising, closing each log file in response to a terminate instruction received from each user-defined function.

7. The method of claim 6, wherein closing further includes freeing memory associated with writing to each of the log files as each log file is closed.

8. A machine-implemented method, comprising:
receiving an instruction to read a log file associated with multiple files, each file having a same directory path and same name and located on a particular node of a network;
resolving the directory path and the name;
searching each node of the network for the name located in the directory path and acquiring the multiple files; and
merging records from the multiple files into a single database table for access via an identifier associated with the log file.

9. The method of claim 8, wherein receiving further includes acquiring with the instruction the directory path, the name, and a job identifier.

10. The method of claim 9, wherein receiving further includes receiving the instructions from within a user-defined function as an application programming interface (API) call.

11. The method of claim 9, wherein resolving further includes constructing a file identifier using the directory path, the name, the job identifier, and a log file type concatenated together as a string representing the file identifier.

12. The method of claim 8, wherein searching further includes opening a file associated with the name on each node when present on that node and reading each record from that file.

13. The method of claim 12, wherein merging further includes acquiring a log file identifier for the table and populating a field within each table record with the log file identifier.

14. The method of claim 13, wherein merging further includes populating additional fields of each table record with dates, times, and messages extracted from each file opened.

15. A system comprising:
a database accessible from a machine-accessible medium; and
an application programming interface (API) implemented in a machine-accessible medium and callable from within user-defined functions that execute on nodes of a network, each user-defined function processing on a different node of the network and each user-defined function making calls to the API to initialize its own log file on its node and to write to that log file and close that log file when that particular user-defined function is finished, and wherein the log files on the nodes are merged together as a single database table within the database when the log files are requested for access.

16. The system of claim 15, wherein at least one call to the API permits all the log files to be opened and merged into the single database table.

17. The system of claim 15, wherein the database table can be viewed and accessed using a query interface associated with the database.

18. The system of claim 15, wherein the user-defined functions provide a directory path, file name, and job identifier for each initialization call made to the API.

19. The system of claim 18, wherein a same file identifier is created for each log file on each node of the network by concatenating the directory path, file name, job identifier, and log file type together.

20. The system of claim 15, wherein the single database table of the database is identified by a log file identifier created to represent each of the log files as a whole and used to reference the single database table within the database.
